(19) United States
(12) Patent Application Publication
(10) Pub. No.: US 2010/0259564 A1
(43) Pub. Date: Oct. 14, 2010

(54) DISPLAY DRIVING INTEGRATED CIRCUIT AND DISPLAY DRIVING SYSTEM

(75) Inventors: Yong-Sung Ahn, Ansan-si (KR); Dae-Seong Kim, Daejeon-si (KR); Dae-Keun Han, Daejeon-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: SILICON WORKS CO., LTD, Daejeon-si (KR)

(21) Appl. No.: 12/678,999

(22) PCT Filed: Sep. 29, 2008
(86) PCT No.: PCT/KR08/05728

§ 371 Date: Mar. 18, 2010

(30) Foreign Application Priority Data
Oct. 5, 2007 (KR) 10-2007-0100082

(51) Int. Cl. G06F 3/038

(52) U.S. Cl. 345/690

(57) ABSTRACT

Provided is a high-resolution display driving system without a new design of interfaces between a timing controller and DDIs, particularly, without an entire change of a DAC unit having a role of determining gradation representation of DDIs and offsets between channels. The high-resolution display driving system includes a timing controller and a DDI unit. The timing controller generates a differential clock signal and differential data. The DDI unit generates a plurality of converted signals corresponding to the differential data in response to an operation instructing signal, a reset/enable signal, and the differential clock signal. A scheme of data transmission from the timing controller to the DDI unit is at least one of a multi-drop scheme and an m-LVDS (mini low voltage differential signaling) scheme.

### BACKGROUND OF THE INVENTION

1. Field of the Invention

The present invention relates to a display driving IC, and more particularly, to a display driving IC capable of implementing high resolution and a display driving system having the display driving IC.

2. Description of the Related Art

A display apparatus converts digital signals containing image information to analog signals so as for a human to see image on a display panel. A digital-to-analog converter (DAC) generates analog signals corresponding to digital signals by using a resistor string which includes a plurality of serially-connected resistors. In order to convert an N-bit (N is an integer) digital signal to a corresponding analog signal, the resistor string needs to include at least (2^{N}+1) resistors.

A resolution of a display apparatus is determined based on diversity of colors and brightness which can be represented by each of picture elements in the display panel. The diversity of colors and brightness also relates to the number of bits which represent each picture element. As the number of bits of image data which can be represented by one picture element is increased by one, the number of resistors in the resistor string needs to be increased by two times. Accordingly, as the resolution of the display apparatus is increased, an area of the resistor string needs to be increased by two times. In addition, as the number of resistors in the resistor string is increased, the number of switches connected to the resistors is also increased. Therefore, the number of metal lines connected to the switches to drive the switches is increased, so that an area of a display driving IC (DDI) included in the DAC is greatly increased.

In order to solve the problem, there has been proposed a DAC which converts the digital signal to the analog signal by using two capacitors and switches connected thereto. The DAC having the capacitors and the switches has an advantage in that the area required for implementing an increasing-resolution display apparatus is not increased so that it is possible to decrease an area occupied by the DDI in comparison with the DAC using the resistor string.

In the DAC using the capacitors and the switches, in order to convert the digital signal to the corresponding analog signal, there is a need for a process of charging one capacitor with a predetermined voltage corresponding to the digital signal and, sequentially, distributing charges stored in the capacitor to another capacitor. The process can be performed by turning on and off switches connected to the two capacitors. However, too much time is taken for the charging and discharge of the capacitors. In order to solve the problem of the DAC, that is, to reduce the time taken for signal conversion, there has been proposed a PPDS (point-to-point differential signal) scheme. Here, the “PPDS” scheme where two associated function blocks are connected to each other in a one-to-one correspondence manner is a counterpart of a multi-drop scheme where one function block is simultaneously connected to multiple function blocks.

FIG. 1 is a partial view showing a conventional high-resolution display driving system employing a PPDS scheme.

Referring to FIG. 1, the display driving system 100 includes a plurality of DDIs 121 to 128 and a timing controller 110 which applies differential data DData and a differential clock signal DClk to a plurality of the DDIs 121 to 128. The timing controller 110 and a plurality of the DDIs 121 to 128 are constructed in a point-to-point interface scheme.

The timing controller 110 transmits to the DDIs 121 to 128 the differential data DData and the differential clock signal DClk in the one-to-one correspondence manner. Each of the DDIs 121 to 128 outputs a plurality of converted signals A0 to AN (N is an integer) corresponding to the differential data DDdata by using the differential data DData and the differential clock signal DClk. The converted signals A0 to AN are transmitted to the corresponding picture elements in the display panel. Here, “A” in the reference numerals of the converted signals denotes analog signals.

FIG. 2 is a block diagram showing an internal construction of a DDI shown in FIG. 1.

Referring to FIG. 2, the DDI includes an input unit 210, a data processor 220, a DAC unit 230, a reference voltage/current generating circuit 240, and a gamma reference voltage generating circuit 250.

In response to a reference voltage Vref, a reference current Iref, and a clock correction signal Clock correction signal, Clk_CR, the input unit 210 processes a differential data DData and a differential clock signal DClk to generate an internal clock signal CLK and a data signal DATA. The differential data DData and the differential clock signal DClk have a format of a differential signal. The internal clock signal CLK and the data signal DATA become CMOS level signals.

The data processor 220 generates serial a data bus control signal DATA_BUS, a DAC control signal DAC control, and a clock correction signal Clk_CR based on the internal clock signal CLK and the data signal DATA. The DAC unit 230 includes a plurality of DAC blocks which generate a plurality of converted signals A0 to AN based on a plurality of gamma reference voltages VHH, VHM, VHL, VLH, and VLM, VLL, the serial data bus control signal DATA_BUS, and the DAC control signal DAC_control. The reference voltage/current generating circuit 240 generates the reference voltage Vref and the reference current Iref. The gamma reference voltage generating circuit 250 generates a plurality of the gamma reference voltages VHH, VHM, VHL, VLH, VLM, and VLL.

FIG. 3 is a circuit view showing a DAC block included in a DAC unit shown in FIG. 2.

Referring to FIG. 3, the DAC block includes a VH DAC 310 and a VL DAC 320.

In response to a sign bit SIGN which is the MSB and remaining bits BIT contained in the serial data bus signal DATA BUS and switch control signals 51 and S2 contained in the DAC control signal DAC_control, the VH DAC 310 switches three gamma reference voltages VHH, VHM, and VHL to output a first converted voltage A0.

The three gamma reference voltages VHH, VHM, and VHL are charged in a first capacitor C1 according to switching operations of two switches SW1 and SW2 controlled by the MSB (SIGN) and the remaining bits BIT and a third switch SW3 controlled by the first switch control signal. Charges stored in the first capacitor C1 are distributed to a second capacitor C2 according to the switching operation of a fourth switch SW4 controlled by the second switch control signal S2 general, the first and second capacitors C1 and C2 are designed to have the same capacitance.

In response to the sign bit SIGN which is the MSB and the remaining bits BIT contained in the serial data but signal DATA BUS and the switch control signals S1 and S2 contained in the DAC control signal DAC_control, the VL DAC 320 switches three gamma reference voltages VLH, VLM, and VLL to output a second converted voltage A1.

The operations of the VL DAC 320 are the same as the operations of the VH DAC 310 except that the gamma reference voltages are different. Therefore, description of the operations of the VL DAC 320 is omitted. Here, the gamma reference voltages VHH, VHM, and VHL have higher voltages levels than the gamma reference voltages VLH, VLM, and VLL. In some cases, these gamma reference voltages may be constructed with voltage having different polarities such as positive and negative voltages.

As described above, the DAC using capacitors may be used to reduce the area occupied by the resistor string involved in an increase of the resolution, and the interfaces between the timing controller 110 and the DDIs 121 to 128 may be implemented in the PPDS scheme.

However, since a current interface standard of a display system is an m-LVDS (mini-low voltage differential signaling) scheme, new interfaces between the timing controller and the DDIs needs to be designed so as for the PPDS scheme to be used for the display system. Particularly, there is a problem in that the DAC unit having a role of gradation representation of DDIs and offsets between channels needs to be entirely changed.

### SUMMARY OF THE INVENTION

The present invention provides a display driving IC capable of implementing high resolution without a new design of interfaces between a timing controller and DDIs, particularly, without an entire change of a DAC unit having a role of determining gradation representation of DDIs and offsets between channels.

The present invention provides a display driving system having a display driving IC capable of implementing high resolution.

According to an aspect of the present invention, there is provided a display driving IC comprising a timing controller and a DDI unit. The timing controller generates a differential clock signal and differential data. The DDI unit generates a plurality of converted signals corresponding to the differential data in response to an operation instructing signal, a reset/enable signal, and the differential clock signal. A scheme of data transmission from the timing controller to the DDI unit is at least one of a multi-drop scheme and an m-LVDS scheme.

According to another aspect of the present invention, there is provided a display driving system comprising: a timing controller which generates a differential clock signal and differential data; and a DDI unit which generates a plurality of converted signals corresponding to the differential data in response to an operation instructing signal, a reset/enable signal, a polarity select signal, and the differential clock signal, wherein the DDI unit comprises a plurality of DDIs, wherein each DDI comprises: a plurality of capacitors; a plurality of gamma reference voltage selecting switches which select the gamma reference voltages corresponding to the data; and a plurality of charging/distributing switches which charge and distribute the selected gamma reference voltages to a plurality of the capacitors in response to the switch control signals, and wherein a scheme of data transmission from the timing controller to the DDI unit is at least one of a multi-drop scheme and an m-LVDS scheme.

According to the present invention, it is possible to implement high-resolution display driving IC and a display driving system having the display driving IC without a change of an m-LVDS interface scheme which is a standard interface scheme between a timing controller and DDIs.

### BRIEF DESCRIPTION OF THE DRAWINGS

The above and other features and advantages of the present invention will become more apparent by describing in detail exemplary embodiments thereof with reference to the attached drawings in which:

FIG. 1 is a partial view showing a conventional high-resolution display driving system employing a PPDS scheme;

FIG. 2 is a block diagram showing an internal construction of a DDI shown in FIG. 1;

FIG. 3 is a circuit view showing a DAC block included in a DAC unit shown in FIG. 2;

FIG. 4 is a partial view showing a display driving system according to the present invention;

FIG. 5 is a block diagram showing a display driving IC according to the present invention;

FIG. 6 is a circuit view showing an actual display driving IC shown in FIG. 5, according to the present invention;

FIG. 7 is a view showing a unitary conversion circuit included in a data serial conversion circuit 640 shown in FIG. 6; and

FIG. 8 is a waveform view showing signals used for the unitary conversion circuit shown in FIG. 7.

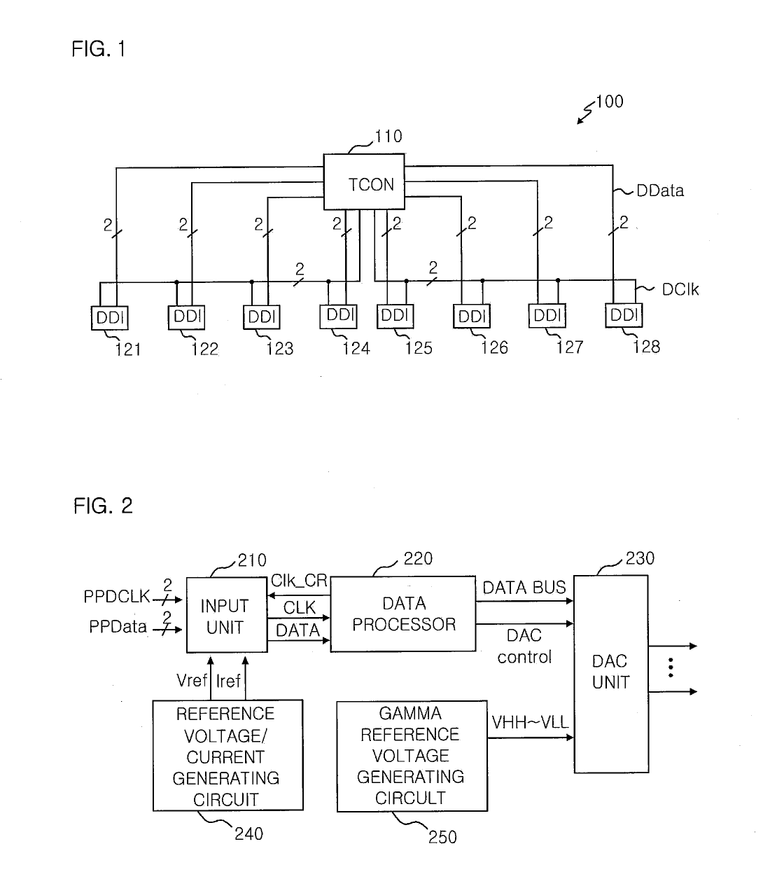

### DETAILED DESCRIPTION OF THE INVENTION

Hereinafter, exemplary embodiments of the present invention will be described in detail with reference to the accompanying drawings.

FIG. 4 is a partial view showing a display driving system according to the present invention.

Referring to FIG. 4, the display driving system 400 includes a timing controller 410 having an m-LVDS (mini Low Voltage Differential Signaling) type interface and a plurality of DDIs 421 to 428.

Differential clock signals DClk and differential data DData generated by the timing controller 410 are transmitted to a plurality of the DDIs 421 to 428 in a multi-drop scheme.

Similarly to a conventional technique where the differential clock signal DClk is transmitted to a plurality of the DDIs 421 to 428 in the multi-drop scheme, in the present invention, the differential clock signal DClk is transmitted in the multi-drop scheme. However, unlike the conventional technique, in the present invention, the interfaces between the timing controller 410 and a plurality of the DDIs 421 to 428 are constructed in the m-LVDS scheme.

In addition to the differential clock signal DClk and the differential data DData, each of the DDIs 421 to 428 receives an operation instructing signal LOAD. The start of operations of the DDIs is controlled based on enable instructing signals R/En and Eo1 to Eo7.

Among the DDIs 421 to 428, operations of a first DDI 421 are controlled based on a reset/enable signal R/En for instructing resetting and enabling. The first DDI 421 generates a first enable signal Eo1 for controlling operations of a second DDI 422 connected serially. In response to the first enable signal Eo1, the second DDI 422 generates a second enable signal Eo2 for controlling operations of a third DDI 423 connected serially. Other serially-connected DDIs 423 to 428 are also sequentially enabled and operated in the same scheme. A plurality of converted signals A0 to AN (N is an integer) output from respective DDIs 421 to 428 are transmitted to a display panel.

The operation instructing signals LOAD applied to the DDIs 421 to 428 are signals for instructing start of processing data.

The 2-bit differential clock signal DClk and the 2 (or more)-bit differential data DData are transmitted from the timing controller 410 to the DDIs 421 to 428 in parallel.

Although the differential data DData is a 12-bit data in FIG. 4, the number of bits in the differential data may be different among systems.

Since signals used for communication between conventional timing controller ICs and interface ICs swing between the highest and lowest power voltages, there are problems of low data transmission rate, high power consumption, and poor electromagnetic interference (EMI) characteristic. In order to solve the problems, there has been proposed an LVDS scheme where a size of the signal used for communication is reduced. Therefore, the LVDS scheme is referred to as a reduced signal differential signaling (RSDS) scheme. In comparison with conventional technologies using transistor-transistor level (TTL) or CMOS level, the LVDS scheme implements improved EMI characteristic and high transmission rate.

In comparison with the LVDS scheme, in the m-LVDS scheme used as a current standard of interfaces for a display system, a magnitude of the swing voltage is further reduced. Since the magnitude of the swing voltage is very small, the m-LVDS has advantages of reduced power consumption, low-EMI characteristic, low price, and high transmission rate. Therefore, the m-LVDS scheme is considered to be available for a high-resolution liquid crystal display (LCD) panel.

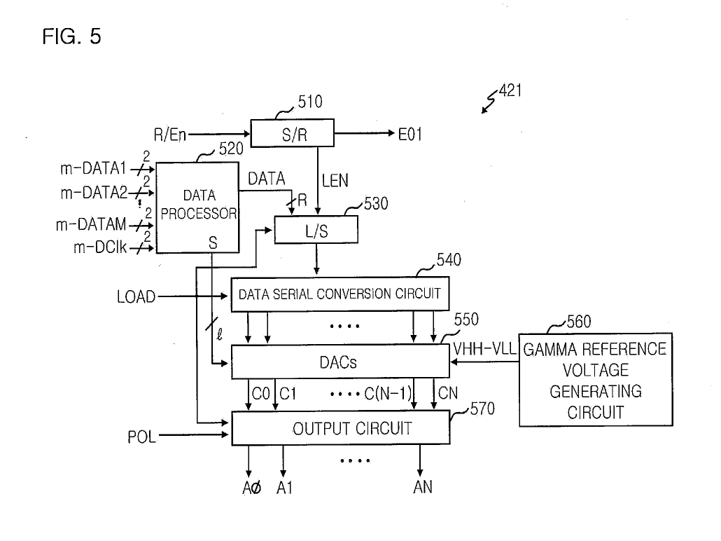

FIG. 5 is a block diagram showing a display driving IC according to the present invention.

The display driving IC shown in FIG. 5 is contrived to implement high resolution. The display driving IC is used as each of the DDIs 421 to 428.

Referring to FIG. 5, the display driving IC 421 is a first DDI 421 of the DDIs shown in FIG. 4. The display driving IC 421 includes a shift register array 510, a data processor 520, a line register 530, a data serial conversion circuit 540, a DAC unit 550, a gamma reference voltage generating circuit 560, and an output circuit 570.

In response to a reset/enable signal R/En, the shift register array 510 generates a line register enable signal LEN for enabling the line register 530 and a first enable signal Eo1 for instructing enabling of the serially-connected DDIs (422 in FIG. 4). Although a signal shift register is shown to be included in the shift register array 510 in FIG. 5, the shift register array includes a plurality of the shift registers. In addition, the line register enable signal LEN is generated by each of the shift registers. Referring to FIG. 4, the first enable signal Eo1 is transmitted to the second DDI 422.

The data processor 520 generates R-bit data DATA (R is an integer) which are output in parallel through k lines (k is an integer) and switch control signals S which are output through I lines (I is an integer) by using the differential data m-DATA1-m-DATAM (M is an integer) and the differential clock signal m-DClk which are input in parallel from the timing controller 410.

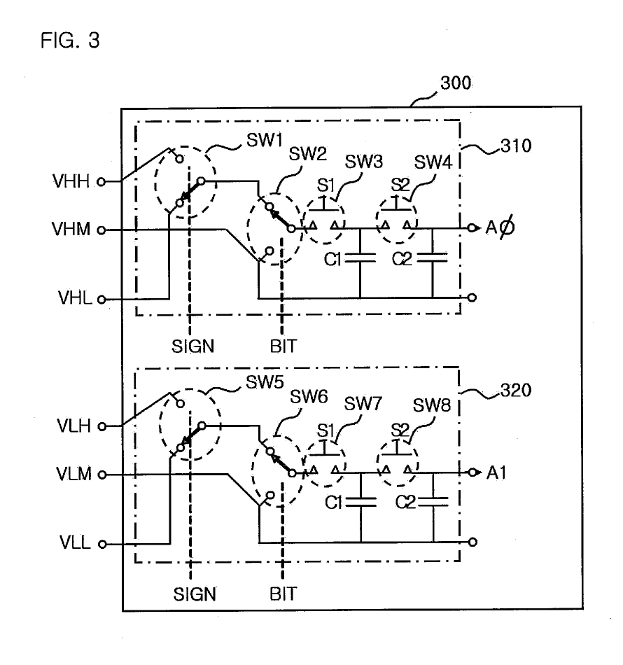

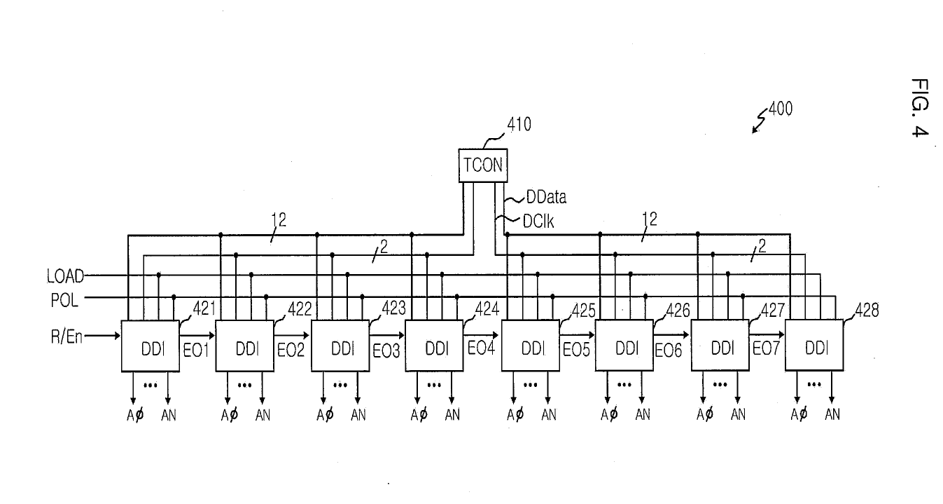

The unitary data DATA corresponding to the picture element are transmitted through the line register 530 and the data serial conversion circuit 540 to the DAC unit 550. Referring to FIG. 3, the data DATA includes a sign bit SIGN which is the most significant bit (MSB) and the remaining data bits BIT. The sign bit SIGN is used to control switching on and off the first switch SW1 to select one of the first and third gamma reference voltages VHH and VHL. The subsequent remaining data bits BIT are used to select one of the voltage selected by the first switch SW1 and the second gamma reference voltage VHM. The data DATA are transmitted through a plurality of signal lines to the line register 530.

Unitary picture-element data for representing one picture element are serially transmitted through one signal line, and unitary picture-element data for representing adjacent picture element are serially transmitted through another signal line. That is, picture-element data for representing a plurality of the picture elements are serially transmitted through a plurality of the parallel signal lines.

The switch control signals S correspond to a third switch control signal S1 and a fourth switch control signal S2. The third switch control signal S1 is used to control switching on and off the third switch SW3 to transmit predetermined charges applied through the second switch SW2 to the first capacitor C1. As described above, during the time that the charges corresponding to the data DATA are transmitted through the second switch SW2 to one port of the first capacitor C1, the third switch SW3 needs to be switched on. After the charges corresponding to the unitary data DATA corresponding to one picture element are stored in the first capacitor C1, the fourth switch control signal S2 is used to control switching on and off of the fourth switch SW4 to distribute the charges stored in the first capacitor C1 to the second capacitor C2.

Since the differential data DData shown in FIG. 4 are applied in parallel, the differential data DData may be more specifically denoted by reference numerals m-DATA1 to m-DATAM. Here, “m” is an abbreviation of “mini” denoting that the signals are transmitted in the m-LVDS scheme. The differential data m-DATA1 to m-DATAM are input to the data processor 520 in parallel through two lines.

In response to the line register enable signal LEN and the operation instructing signal LOAD, the line register 530 stores the data DATA which are applied in parallel.

In response to the operation instructing signal LOAD, the data serial conversion circuit 540 converts the data DATA transmitted from the line register 530 to a serial data.

The DAC unit 550 generates a plurality of analog converted signals C0 to CN corresponding to the data DATA which are serially converted and applied by the data serial conversion circuit 540, by using the switch control signals S and the gamma reference voltages VHH to VLL.

The gamma reference voltage generating circuit 560 generates the gamma reference voltages VHH to VLL. Among the gamma reference voltages VHH to VLL, three gamma reference voltages VHH, VHM, and VHL have higher voltage levels than the remaining three gamma reference voltages VLH, VLM, and VLL. In some cases, these gamma reference voltages may be constructed with voltages having different polarities such as positive and negative voltages.

In response to the operation instructing signal LOAD and the selection control signal POL, the output circuit 570 buffers the analog converted signals C0 to CN to output a plurality of the converted signals A0 to AN. The selection control signal is used to determine polarities of the analog converted signals C0 to CN.

For the convenience of description of the high-resolution display driving system according to the present invention, a scheme of data transmission from the timing controller to the DDI unit is described to be a combination of the multi-drop scheme and the m-LVDS scheme. However, the schemes may be individually employed to the high-resolution display driving system according to the present invention.

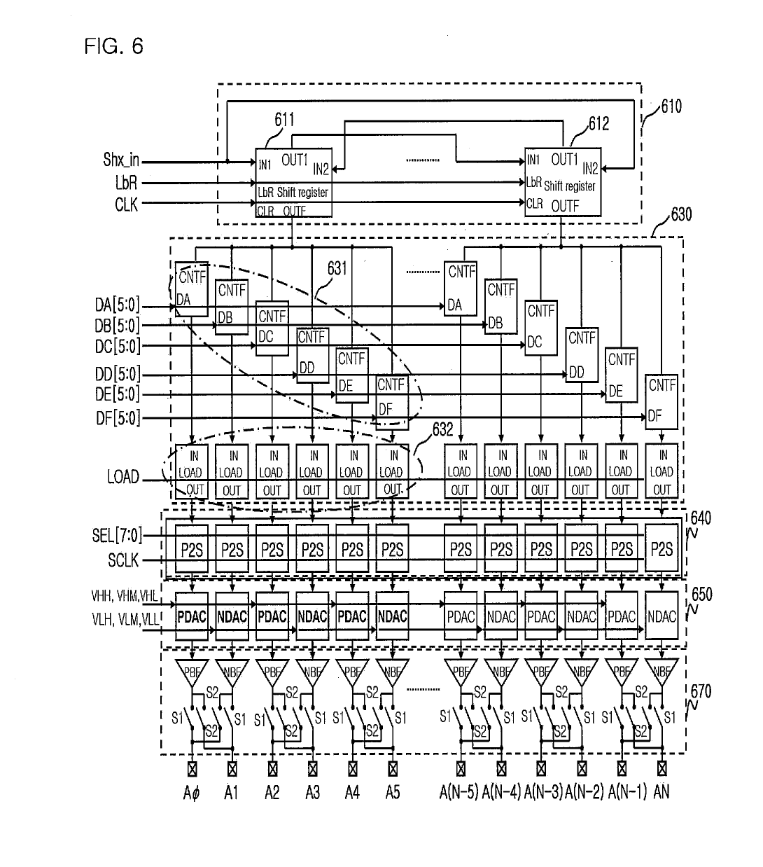

FIG. 6 is a circuit view showing an actual display driving IC shown in FIG. 5, according to the present invention.

A shift register array 610, a line register 630, a data serial conversion circuit 640, a DAC unit 650, and an output circuit 670 shown in FIG. 6 correspond to the shift register array 510, the line register 530, the data serial conversion circuit 540, the DAC unit 550, and the output circuit 570 shown in FIG. 5. The data processor 520 and the gamma reference voltage generating circuit 560 shown in FIG. 5 are not shown in FIG. 6.

The shift register array 610 includes a plurality of shift registers 611 to 612 serially connected. The enable signals OUTF generated by the shift register 611 to 612 are output in a direction from the left to the right or the opposite direction according to a shift direction control signal LbR. The reset/enable signal Shx_in which is input to the shift register array 610 corresponds to the reset/enable signal R/En shown in FIG. 5.

The line register 630 includes a primary storage shift register array 631 which sequentially stores the data DATA (DA to DF) received from the data processor 520 and a secondary storage shift register array 632 which stores the data stored in the primary storage shift register in response to the operation instructing signal LOAD. A 6-bit data DA[5:0] for representing one picture element is transmitted in parallel and stored in the first shift register of the primary storage shift register array 631. Although a single shift register is shown in the figure, six shift registers are connected in parallel. Similarly, a 6-bit data DB[5:0] for representing adjacent one picture element is transmitted serially and stored in the second shift register. Sequentially, 6-bit data DC[5:0] to DF[5:0] for representing other adjacent picture elements are stored in the third to sixth shift registers.

The data stored in the primary storage shift register array 631 are used to represent a single frame. Therefore, in order to represent the current frame simultaneously while receiving the data for representing the next frame, the data for representing the current frame are stored in the secondary storage shift register array 632.

The data serial conversion circuit 640 converts the picture-element data which are output in parallel from the secondary storage shift register 632 to serial data and stores the serial data. The DAC unit 650 generates analog signals corresponding to the picture-element data which are transmitted serially from the data serial conversion circuit 640. The DACs 650 are classified into two types of DACs. Referring to FIG. 3, an upper DAC may be referred to as a PDAC, and a lower DAC may be referred to as an NDAC. The output circuit 670 buffers and outputs the analog signals output from the DAC unit 650.

Referring to the shift register array 610 and the line register 630 described above, the enable signals LEN which are output from the shift registers included in the shift register array 610 are used to control operations of the six shift registers of the primary storage shift register array 631. The picture-element data stored in the primary storage shift register array 631 are output through the corresponding secondary storage shift registers, DACs and buffers to the corresponding picture elements.

In the description with reference to FIG. 6, the term “array” is used to imply that a plurality of registers are included in the array. Therefore, it should be noted that a single block referred to as an array includes a plurality of function blocks having the same function.

Referring to FIG. 6, each of the shift registers included in the shift register array 610 is used to control transmission of data to six picture elements.

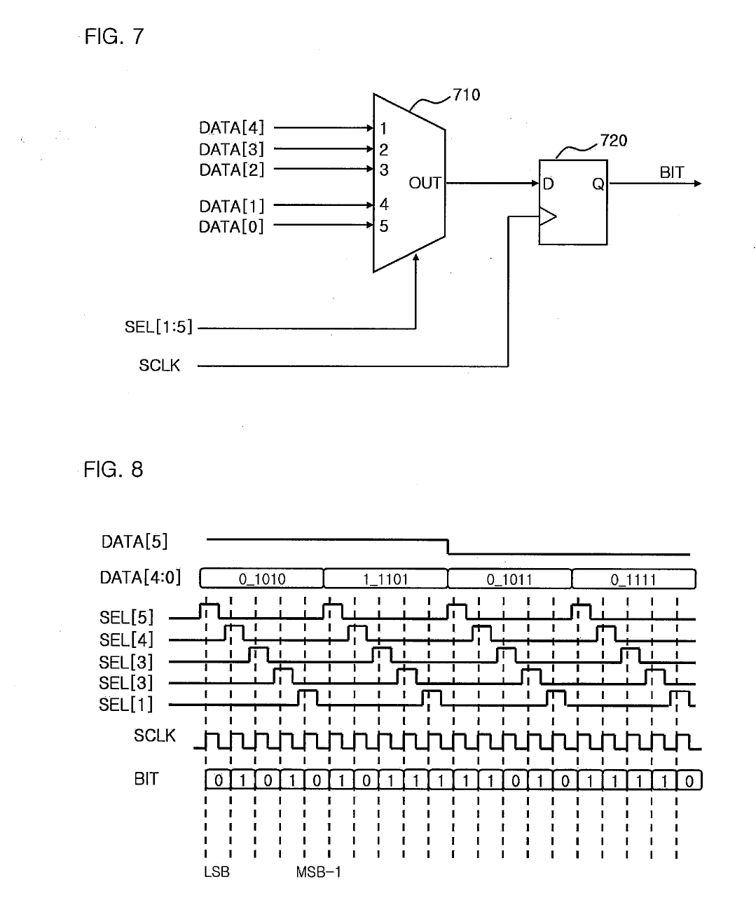

FIG. 7 is a view showing a unitary conversion circuit included in a data serial conversion circuit 640 shown in FIG. 6.

Referring to FIG. 7, the unitary conversion circuit P2S includes a multiplexer 710 and a D-flip-flop 720. The multiplexer 710 sequentially selects 5-bit picture-element data DATA[4] to DATA[0] which are input in parallel, in response to the selection control signal SEL[1:5] generated by the data processor. The D-flip-flop 720 stores the picture-element data serially output from the multiplexer 710 and outputs data BIT according to the clock signal SCLK generated by the data processor. A single picture element can be represented with 6 bits of the picture element data. In FIG. 7, the data BIT denote the remaining bits except for the sign bit SIGN which is the MSB.

FIG. 8 is a waveform view showing signals used for the unitary conversion circuit shown in FIG. 7.

Referring to FIG. 8, picture-element data corresponding to four frames are shown to be converted. The MSB DATA[5] of the picture-element data of the first two frames is 1, and the MSB of the next two frames is 0.

The remaining 5-bit picture-element data of the first frame having the MSB of 1 is 01010, and the remaining 5-bit picture-element data of the second frame is 11101. The remaining 5-bit picture-element data of the third frame having the MSB of 0 is 10111, and the remaining 5-bit picture-element data of the fourth frame is 01111. The 5 bits are sequentially selected based on the selection control signal SEL[1:5] generated by the data processor and applied and stored to the flip-flop 720 according to the clock signal SCLK which is generated by the data processor based on the m-DCLK input to the DDI.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A display driving integrated circuit comprising:
a shift register array which generates an enable signal and a plurality of line register enable signals in response to a reset/enable signal;
a data processor which generates R-bit data (R is an integer) output in parallel through k lines (k is an integer) and switch control signals output through I lines (I is an integer) based on a plurality of differential data and a differential clock signal which are input in parallel;
a line register which stores the data in response to the line register enable signal and an operation instructing signal;
a data serial conversion circuit which converts the data transmitted from the line register to a serial data in response to the operation instructing signal; and
a DAC unit which generates a plurality of converted signals corresponding to the serial data which are obtained by the data serial conversion circuit, based on the switch control signals and a plurality of gamma reference voltages.

2. The display driving integrated circuit of claim 1, further comprising a gamma reference voltage generating circuit which generates a plurality of the gamma reference voltages.

3. The display driving integrated circuit of claim 1, further comprising an output circuit which buffers and outputs a plurality of the converted signals output from the DAC unit, in response to the operation instructing signal and the polarity select signal.

4. The display driving integrated circuit of claim 1,
wherein the shift register array comprises a plurality of serially-connected shift registers which generate line register enable signals for the corresponding line registers, and
wherein one of two end shift registers generates the first enable signal.

5. The display driving integrated circuit of claim 1, wherein the line register comprises:
a primary storage shift register array including a plurality of shift registers which stores data in response to the line register enable signal; and
a secondary storage shift register array including a plurality of shift registers which stores data output from the primary storage shift register array in response to the operation instructing signal.

6. The display driving integrated circuit of claim 1, wherein the DAC unit comprises a plurality of DACs, each of which comprises:
a plurality of capacitors;
a plurality of gamma reference voltage selecting switches which select the gamma reference voltages corresponding to the data; and
a plurality of charging/distributing switches which charge and distribute the selected gamma reference voltages to a plurality of the capacitors in response to the switch control signals.

7. A display driving system comprising:
a timing controller which generates a differential clock signal and differential data; and
a DDI unit which generates a plurality of converted signals corresponding to the differential data in response to an operation instructing signal, a reset/enable signal, a polarity select signal, and the differential clock signal,
wherein the DDI unit comprises a plurality of DDIs,
wherein each DDI comprises:
a plurality of capacitors;
a plurality of gamma reference voltage selecting switches which select the gamma reference voltages corresponding to the data; and
a plurality of charging/distributing switches which charge and distribute the selected gamma reference voltages to a plurality of the capacitors in response to the switch control signals, and
wherein a scheme of data transmission from the timing controller to the DDI unit is at least one of a multi-drop scheme and an m-LVDS scheme.

8. The display driving system of claim 7, wherein the DDI unit comprises:
a first DDI which generates a first enable signal and a plurality of the converted signals corresponding to the differential data in response to the operation instructing signal, the reset/enable signal, and the differential clock signal;
a second DDI which generates a second enable signal and a plurality of the converted signals corresponding to the differential data in response to the operation instructing signal, the first enable signal, and the differential clock signal;
an (N-1)-th DDI which generates an (N-1)-th enable signal (N is an integer) and a plurality of the converted signals corresponding to the differential data in response to the operation instructing signal, an (N-2)-th enable signal, and the differential clock signal; and
an N-th DDI which generates a plurality of the converted signals corresponding to the differential data in response to the operation instructing signal, an (N-1)-th enable signal, and the differential clock signal.

9. The display driving system of claim 7,
wherein the first DDI comprises:
a shift register array which generates the first enable signal and line register enable signal in response to the reset/enable signal;
a data processor which generates R-bit data (R is an integer) output in parallel through k lines (k is an integer) and switch control signals output through l lines (I is an integer) based on a differential clock signal and differential data having multiple bits which are input in parallel;
a line register which stores the parallel differential data in response to the line register enable signal and the operation instructing signal;
a data serial conversion circuit which converts the parallel differential data transmitted from the line register to a serial data in response to the operation instructing signal; and
a DAC unit which generates a plurality of converted signals corresponding to the serial data which are obtained and applied by the data serial conversion circuit, based on the switch control signals and a plurality of gamma reference voltages,
wherein the second DDI comprises:
a shift register array which generates the second enable signal and line register enable signal in response to the first enable signal;
a data processor which generates R-bit data output in parallel through k lines and switch control signals output through l lines based on a differential clock signal and differential data having multiple bits which are input in parallel;
a line register which stores the parallel differential data in response to the line register enable signal and the operation instructing signal;
a data serial conversion circuit which converts the parallel differential data transmitted from the line register to a serial data in response to the operation instructing signal; and
a DAC unit which generates a plurality of converted signals corresponding to the serial data which are obtained and applied by the data serial conversion circuit, based on the switch control signals and a plurality of gamma reference voltages, wherein the (N-1)-th DDI comprises:
a shift register array which generates the (N-1)-th enable signal and line register enable signal in response to the (N-2)-th reset/enable signal;
a data processor which generates R-bit data output in parallel through k lines and switch control signals output through l lines based on a differential clock signal and differential data having multiple bits which are input in parallel;
a line register which stores the parallel differential data in response to the line register enable signal and the operation instructing signal;
a data serial conversion circuit which converts the data transmitted from the line register to a serial data in response to the operation instructing signal; and
a DAC unit which generates a plurality of converted signals corresponding to the serial data which are obtained and applied by the data serial conversion circuit, based on the switch control signals and a plurality of gamma reference voltages, and
wherein the N-th DDI comprises:
a shift register array which generates the line register enable signal in response to the (N-1)-th reset/enable signal;
a data processor which generates R-bit data output in parallel through k lines and switch control signals output through l lines based on a differential clock signal and differential data having multiple bits which are input in parallel;
a line register which stores the parallel differential data in response to the line register enable signal and the operation instructing signal;
a data serial conversion circuit which converts the data transmitted from the line register to a serial data in response to the operation instructing signal; and
a DAC unit which generates a plurality of converted signals corresponding to the serial data which are obtained and applied by the data serial conversion circuit, based on the switch control signals and a plurality of gamma reference voltages.

10. The display driving system of claim 9, wherein each of the first to N-th DDIs further comprises a gamma reference voltage generating circuit which generates a plurality of the gamma reference voltages.

11. The display driving system of claim 9, wherein each of the first to N-th DDIs further comprises an output circuit which buffers and outputs a plurality of the converted signals output from the DAC unit, in response to the operation instructing signal and the polarity select signal.

12. The display driving system of claim 9,
wherein the shift register array included in each of the first to N-th DDIs comprises a plurality of serially-connected shift registers which generate line register enable signals for the corresponding line registers, and
wherein one of two end shift registers generates the second to N-th enable signals.

13. The display driving system of claim 9, wherein the line register included in each of the first to N-th DDIs comprises:
a primary storage shift register array including a plurality of shift registers which stores data in response to the line register enable signal; and
a secondary storage shift register array including a plurality of shift registers which stores data output from the primary storage shift register array in response to the operation instructing signal.
